(19) United States
(12) Patent Application Publication
(10) Pub. No.: US 2014/0357296 A1
(43) Pub. Date: Dec. 4, 2014

(54) LOCATING METHOD AND LOCATING SYSTEM

(71) Applicants: Zhongliang Deng, Beijing (CN); Ziping Lv, Beijing (CN); Huli Shi, Beijing (CN); Yanpei Yu, Beijing (CN); Xie Yuan, Beijing (CN); Risu Na, Beijing (CN); Hemin Li, Beijing (CN); Qifeng Lai, Beijing (CN); Lianming Xu, Beijing (CN)

(72) Inventors: Zhongliang Deng, Beijing (CN); Ziping Lv, Beijing (CN); Huli Shi, Beijing (CN); Yanpei Yu, Beijing (CN); Xie Yuan, Beijing (CN); Risu Na, Beijing (CN); Hemin Li, Beijing (CN); Qifeng Lai, Beijing (CN); Lianming Xu, Beijing (CN)

(73) Assignees: BEIJING UNIVERSITY OF POSTS AND TELECOMMUNICATIONS, Beijing (CN); BEIJING SHOUKEXINTONG SCIENCE & TECHNOLOGY CO., LTD, Beijing (CN)

(21) Appl. No.: 14/365,814

(22) PCT Filed: Dec. 19, 2011
(86) PCT No.: PCT/CN2011/084213

§ 371 Date: Jun. 16, 2014

(51) Int. Cl. H04W 4/02

(52) U.S. Cl. CPC H04W 4/02
USPC 455/456.1

(57) ABSTRACT

The present invention, pertaining to the field of communications technologies, discloses a locating method and a locating system. The method includes: receiving a locating request and a locating feature parameter from a terminal, where the locating feature parameter is acquired by demodulating a locating spread spectrum signal inserted in a timeslot header or a transmission frame header of a mobile broadcast signal after the terminal receives the mobile broadcast signal; and locating the terminal by using a grid-based feature parameter matching algorithm according to the locating feature parameter. According to the present invention, a locating feature parameter that is acquired after a terminal demodulates a received mobile broadcast signal is received from the terminal; and the terminal is located by using a grid-based feature parameter matching algorithm according to the locating feature parameter. This, on the premise of not affecting normal receiving and demodulation of mobile broadcast signals, not only achieves an effect of real-time and high-precision location and implements wide-area high-precision location and navigation of mass of terminals, but also implements integration of a broadcast system and a mobile communication system.

### TECHNICAL FIELD

The present invention relates to the field of communications technologies, and in particular, to a locating method and a locating system.

### BACKGROUND

In recent years, development of radio technologies and wireless local area network technologies and increase of location service demands greatly promote advancement of location technologies. Accordingly, people's demands on location based services (LBS) are on the rise. Location information is particularly important especially in cases of emergencies.

In the prior art, during implementation of location, a mobile phone is located with the global positioning system (GPS) plus a base station. The mobile phone comprises a GPS wireless receiver, and a primary processor connected to the GPS wireless receiver. The primary processor is configured with a base station-based location algorithm module. The mobile phone is further configured with a base station signal wireless receiver, which is capable of communicating with a base station location server over a network. A signal output terminal of the base station signal wireless receiver is connected to the base station location server, and a signal output terminal of the base station location server is connected to the base station-based location algorithm module. If no GPS signal is available, the primary processor scans information of neighbor base stations, and sends the scanned information to the base station location server based on a global system of mobile communications (GSM) or general packet radio service (GPRS) network. The location server acquires the location of the mobile phone by calculation by using the information of the neighbor base stations sent by the primary processor and based on an existing database and a specific algorithm.

During the process of the present invention, the inventors find that the prior art at least has the following problem:

GPS satellite signals are weak in intensity, and are subject to interference and reflection caused by an ambient environment, and therefore signal quality severely fluctuates. Due to large changes of signal intensity in a city environment, once a mobile phone is taken indoors, the mobile phone fails to be located. When the mobile phone to be located is located using a base station, the precision is one level poorer than the GPS-based location, falling within a radius range of 100 m to 300 m. Therefore, the locating method in the prior art is unsuitable for high-precision location.

### SUMMARY

To achieve high-precision location, embodiments of the present invention provide a locating method and a locating system. The technical solutions are as follows:

In one aspect, a locating method is provided. The method includes:

receiving a locating request and a locating feature parameter from a terminal, where the locating feature parameter is acquired by demodulating a locating spread spectrum signal inserted in a timeslot header or a transmission frame header of a mobile broadcast signal after the terminal receives the mobile broadcast signal; and

locating the terminal by using a grid-based feature parameter matching algorithm according to the locating feature parameter.

Preferably, prior to the locating the terminal by using a grid-based feature parameter matching algorithm according to the locating feature parameter, the method further includes:

determining whether the locating feature parameter accommodates a locating requirement; and

accordingly, the locating the terminal by using a grid-based feature parameter matching algorithm according to the locating feature parameter includes:

upon determining that the locating feature parameter accommodates the locating requirement, locating the terminal by using the grid-based feature parameter matching algorithm according to the locating feature parameter.

Preferably, prior to the locating the terminal by using a grid-based feature parameter matching algorithm according to the locating feature parameter, the method further includes:

selecting a proper locating manner with reference to a service requirement and a geographic attribute of the terminal according to the locating feature parameter; and

accordingly, the locating the terminal by using a grid-based feature parameter matching algorithm according to the locating feature parameter includes:

locating the terminal by using a grid-based feature parameter matching algorithm according to the locating feature parameter and the selected locating manner.

Preferably, prior to the locating the terminal by using a grid-based feature parameter matching algorithm according to the locating feature parameter, the method further includes:

verifying whether the locating request from the terminal satisfies a locating condition, and

accordingly, the locating the terminal by using a grid-based feature parameter matching algorithm according to the locating feature parameter includes:

upon verifying that the locating request satisfies the locating condition, locating the terminal by using the grid-based feature parameter matching algorithm.

The locating the terminal by using a grid-based feature parameter matching algorithm includes:

performing an analysis of matching between the locating feature parameter and data in a locating feature parameter database by using the grid-based feature parameter matching algorithm, acquiring a geographic location information parameter of the terminal, and processing the geographic location information parameter online in a real-time manner to acquire a locating result.

Further, after the locating the terminal by using a grid-based feature parameter matching algorithm, the method further includes:

generating a charging record for each successful location.

In another aspect, a locating system is provided. The system includes: a parameter return control subsystem and a location service subsystem.

The parameter return control subsystem is configured to receive a locating request and a locating feature parameter from a terminal, and send the locating feature parameter to the location service subsystem, where the locating feature parameter is acquired by demodulating a locating spread spectrum signal inserted in a timeslot header or a transmission frame header of a mobile broadcast signal after the terminal receives the mobile broadcast signal.

The location service subsystem is configured to locate the terminal by using a grid-based feature parameter matching algorithm according to the locating feature parameter sent by the parameter return control subsystem.

Preferably, the parameter return control subsystem is further configured to determine whether the locating feature parameter accommodates a locating requirement.

Accordingly, the location service subsystem is specifically configured to: after the parameter return control subsystem determines that the locating feature parameter accommodates the locating requirement, locate the terminal by using the grid-based feature parameter matching algorithm according to the locating feature parameter.

Preferably, the parameter return control subsystem is further configured to select a proper locating manner with reference to a service requirement and a geographic attribute of the terminal according to the locating feature parameter.

Accordingly, the location service subsystem is configured to locate the terminal by using a grid-based feature parameter matching algorithm according to the locating feature parameter and the locating manner selected by the parameter return control subsystem.

Preferably, the parameter return control subsystem is further configured to verify whether the locating request from the terminal satisfies a locating condition.

Accordingly, the location service subsystem is further configured to: after the parameter return control subsystem verifies that the locating request satisfies the locating condition, locate the terminal by using the grid-based feature parameter matching algorithm.

The location service subsystem is specifically configured to: perform an analysis of matching between the locating feature parameter and data in a locating feature parameter database by using the grid-based feature parameter matching algorithm, acquire a geographic location information parameter of the terminal, and process the geographic location information parameter online in a real-time manner to acquire a locating result.

Furthermore, the device further includes:

a location charging subsystem, configured to generate a charging record for each successful location.

The technical solutions according to the embodiments of the present invention achieve the following beneficial effects:

A locating feature parameter that is acquired after a terminal demodulates a received mobile broadcast signal is received from the terminal; and the terminal is located by using a grid-based feature parameter matching algorithm according to the locating feature parameter. This, on the premise of not affecting normal receiving and demodulation of mobile broadcast signals, not only achieves an effect of real-time and high-precision location and implements wide-area high-precision location and navigation of mass of terminals, but also implements integration of a broadcast system and a mobile communication system. In this way, the problem that the location technology of a wide-area mobile terminal mainly depends on a satellite navigation system is addressed from the location mechanism, and ground mobile broadcast network-based location effectively makes necessary and beneficial complementation for the satellite navigation system-based location.

### BRIEF DESCRIPTION OF THE DRAWINGS

For a better understanding of the technical solutions in the embodiments of the present invention, the accompanying drawings for illustrating the embodiments are briefly described below. Apparently, the accompanying drawings in the following description illustrate only some embodiments of the present invention, and persons of ordinary skill in the art may derive other accompanying drawings based on these accompanying drawings without any creative efforts.

FIG. 1 is a flowchart of a locating method according to Embodiment 1 of the present invention;

FIG. 2 is a schematic model diagram of a location service solution on the network side according to Embodiment 2 of the present invention;

FIG. 3 is a flowchart of a locating method according to Embodiment 2 of the present invention;

FIG. 4 is a schematic structural diagram of a locating system according to Embodiment 3 of the present invention;

FIG. 5 is another schematic structural diagram of the locating system according to Embodiment 3 of the present invention;

FIG. 6 is another schematic structural diagram of a parameter return control subsystem according to Embodiment 3 of the present invention; and

FIG. 7 is a schematic structural diagram of a location service subsystem according to Embodiment 3 of the present invention.

### DETAILED DESCRIPTION

To make the objectives, technical solutions, and advantages of the present invention clearer, embodiments of the present invention are described in detail below with reference to the accompanying drawings.

### Embodiment 1

Referring to FIG. 1, this embodiment provides a locating method, where the method includes the following steps:

Step 101: receiving a locating request and a locating feature parameter from a terminal, where the locating feature parameter is acquired by demodulating a locating spread spectrum signal inserted in a timeslot header or a transmission frame header of a mobile broadcast signal after the terminal receives the mobile broadcast signal; and

Step 102: locating the terminal by using a grid-based feature parameter matching algorithm according to the locating feature parameter.

Further, the locating feature parameters include one or more of a signal delay value, a signal delay difference, a signal strength, an angle of arrival, from each of mobile broadcast base stations to the terminal.

Preferably, prior to the locating the terminal by using a grid-based feature parameter matching algorithm according to the locating feature parameter, the method further includes:

determining whether the locating feature parameter accommodates a locating requirement; and

accordingly, the locating the terminal by using a grid-based feature parameter matching algorithm according to the locating feature parameter includes:

upon determining that the locating feature parameter accommodates the locating requirement, locating the terminal by using the grid-based feature parameter matching algorithm according to the locating feature parameter.

Preferably, prior to the locating the terminal by using a grid-based feature parameter matching algorithm according to the locating feature parameter, the method further includes:

selecting a proper locating manner with reference to a service requirement and a geographic attribute of the terminal according to the locating feature parameter; and

accordingly, the locating the terminal by using a grid-based feature parameter matching algorithm according to the locating feature parameter includes:

locating the terminal by using a grid-based feature parameter matching algorithm according to the locating feature parameter and the selected locating manner.

Preferably, prior to the locating the terminal by using a grid-based feature parameter matching algorithm according to the locating feature parameter, the method further includes:

verifying whether the locating request from the terminal satisfies a locating condition; and

accordingly, the locating the terminal by using a grid-based feature parameter matching algorithm according to the locating feature parameter includes:

upon verifying that the locating request satisfies the locating condition, locating the terminal by using the grid-based feature parameter matching algorithm.

The locating the terminal by using a grid-based feature parameter matching algorithm includes:

performing an analysis of matching between the locating feature parameter and data in a locating feature parameter database by using the grid-based feature parameter matching algorithm, acquiring a geographic location information parameter of the terminal, and processing the geographic location information parameter online in a real-time manner to acquire a locating result.

Furthermore, after the locating the terminal by using a grid-based feature parameter matching algorithm, the method further includes:

generating a charging record for each successful location.

To illustrate the method according to this embodiment more clearly, the method provided by the embodiment will be described in detail using the following Embodiment 2.

### Embodiment 2

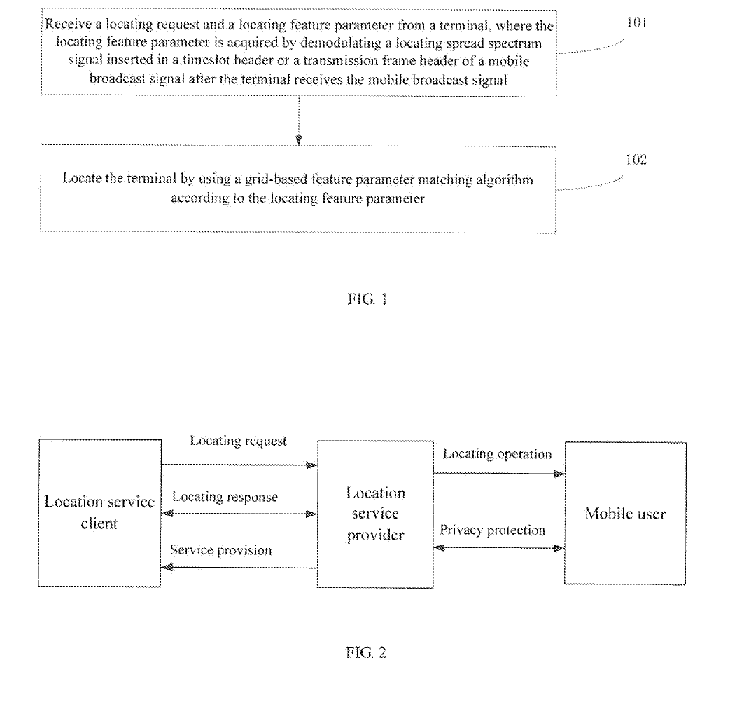

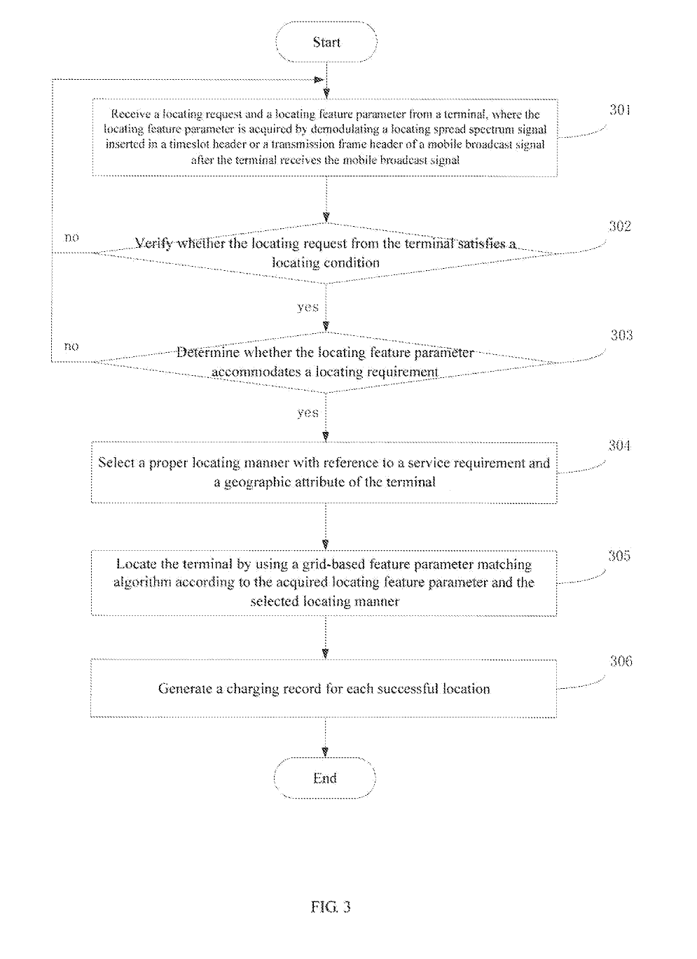

This embodiment provides a locating method. The method is based on the grid matching location technology, and employs a network side location service solution model as shown in FIG. 2. i.e., a client/server model constituted by a location service client, a location service provider, and a mobile user. Preferably, upon receiving a locating request from a location service client, the location service provider verifies whether the location service client is authorized and whether the location service client is authorized to locate a target user. Upon successful verification, the location service provider initiates a location operation, and sends a locating result to the location service client. During the location process, to ensure information security and protect user's privacy, location information needs to be encrypted, and a mobile user may refuse the location action conducted by the location service client. With reference to the network side location service solution model illustrated in FIG. 2, referring to FIG. 3, the locating method according to this embodiment includes the following steps:

Step 301: Receiving a locating request and a locating feature parameter from a terminal, where the locating feature parameter is acquired by demodulating a locating spread spectrum signal inserted in a timeslot header or a transmission frame header of a mobile broadcast signal after the terminal receives the mobile broadcast signal.

This embodiment sets no limitation to the specific locating feature parameter, the locating feature parameter may include but is not limited to one or more of a signal delay value, a signal delay difference, a signal strength, an angle of arrival, from each of mobile broadcast base stations to the terminal. The locating feature parameter is acquired by demodulating a locating spread spectrum signal inserted in a timeslot header or a transmission frame header of a mobile broadcast signal after the terminal receives the mobile broadcast signal. In practice, upon receiving a mobile broadcast signal, the terminal demodulates a locating spread spectrum signal inserted in a timeslot header or a transmission frame header of the mobile broadcast signal to acquire navigation message information, and measures the navigation message information to acquire locating feather parameters. The navigation message information includes an identifier of the mobile broadcast base station, where the locating feature parameter corresponds to the identifier.

Further, upon reception of a locating request from a plurality of terminals or a plurality of locating requests from one terminal, the method according to this embodiment supports sequential processing of the received locating requests based on service priorities and classes.

Step 302: Verifying whether the locating request from the terminal satisfies a locating condition, if the locating condition is satisfied, performing step 303, and otherwise, terminating the process.

With respect to this step, this embodiment sets no limitation to the specific locating condition, and the locating request from the terminal is verified as whether to satisfy the locating condition to ensure user's privacy. During verifying whether the locating request satisfies the locating condition, authentication and authorization check is conducted in a user/content provider (CP) database, and privacy attribute of an involved mobile user is checked to ensure the user's privacy. The user/CP database may prestore privacy attributes of users, for example, information indicating whether location is allowed. This embodiment sets no limitation to the specific privacy attribute.

Step 303: Determining whether the locating feature parameter accommodates a locating requirement, if the locating requirement is accommodated, performing step 304, and otherwise, terminating the process.

This embodiment sets no limitation to the specific locating requirement. During implementation, if few locating feature parameters are acquired or the precision is too low to accommodate the locating requirement, the location may fail. Therefore, it is determined that the acquired locating feature parameter fails to accommodate the locating requirement.

Optionally, the method according to this embodiment further supports implementation of location by using a standby location service subsystem, where in the above case where it is determined that the acquired locating feature parameter fails to accommodate the locating requirement, the standby location subsystem may be further selected for location, and checks the quality of service (QoS) of a returned location report. If the location using the standby location service subsystem fails, the location in this step fails. The function of the standby location service subsystem is the same as that of the location service subsystem failed in location.

Step 304: Selecting a proper locating manner according to the locating feature parameter and in combination of a service requirement and a geographic attribute of the terminal.

With respect to this step, this embodiment still sets no limitation to the specific service requirement and the geographic attribute of the terminal. Generally, a proper locating manner is selected depending on the service requirement and the geographic attribute of the terminal. For example, during selection of a proper locating manner according to the acquired locating feature parameter, if the geographic attribute of the terminal is “indoor”, a manner of location using a base station signal may be selected, or a manner of location using a base station plus complemented system may be selected; if the geographic attribute of the terminal is “outdoor”, and the precision requirement is not high, a manner of location using the cell identifier (Cell-ID) is selected, and if the precision requirement is high, a manner of location using a base station plus a satellite signal may be used.

Step 305: Locating the terminal by using a grid-based feature parameter matching algorithm according to the acquired locating feature parameter and the selected locating manner.

Specifically, in this step, when the terminal is located by using the grid-based feature parameter matching algorithm according to the acquired locating feature parameter and the selected locating manner, this embodiment still sets no limitation to the specific locating manner. In practice, a analysis of matching between the locating feature parameter and data in a locating feature parameter database may be performed by using the grid-based feature parameter matching algorithm, and a geographic location information parameter of the terminal is generated, and the geographic location information parameter is processed online in a real-time manner to acquire a locating result.

During performing of the analysis of matching between the locating feature parameter and data in the locating feature parameter database by using the grid-based feature parameter matching algorithm, the locating feature parameter may be pre-collected, and analysis is made according to the collected locating feature parameter and a model is reasonably established, and an intelligent planning model of the feature grid is researched. Through the intelligent planning model, basic feature unit grids of adaptive size intelligently divided by software may be generated according to the collected locating feature parameter values and data in a locating feature parameter database, to perform a fuzzy matching of the locating feature parameter received in the location process. This embodiment sets no limitation to the specific data in the locating feature parameter database. For example, the specific data may be as listed in Table 1.

TABLE 1

| Item | Field Name | Description | Value |
|---|---|---|---|
| 1 | Network ID | Number of digits | XXXXXXXXX |
| 2 | Network parameter | Number of digits | XXXXXXXXX |
| 3 | Base station ID | Number of digits | XXXXXXXXX |
| 4 | TDOA | Number of digits | XXXXXXXXX |
| 5 | RSSI | Number of digits | XXXXXXXXX |
| 6 | Grid longitude and | Number of digits | XXXXXXXXX |
| | latitude coordinates | | |

In Table 1, “Item” may include even more, and similarly, “Field Name” may include other content in addition to network ID, network parameter, time difference of arrival (TDOA), received signal strength indication (RSSI), and grid longitude and latitude coordinates. This embodiment sets no limitation thereto, and similarly sets no limitation to “Description” and “Value”.

Further, data in the locating feature parameter database may be updated in real time according to construction of base stations, city infrastructures (for example, roads and houses), indoor location demands of the buildings, and electromagnetic environment changes.

Step 306: Generating a charging record for each successful location, and terminating the process.

With respect to this step, this embodiment sets no limitation to the manner of generating the charging record.

It should be noted that, in addition to the above-described steps, the method according to this embodiment further provides an operation and maintenance function, which not only supports operation and maintenance of an operator, but also provides location platform management, application's statistical alarm management and configuration management.

In addition, the above steps 302, 303, 304, and 306 are preferred steps. If these preferred steps are not performed, step 305 may be directly performed to locate the terminal by using the grid-based feature parameter matching algorithm according to the locating feature parameter after step 301 is performed.

If the method according to this embodiment further includes the preferred step 302 in addition to step 301 and step 305, after step 301 is performed and it is verified in step 302 that the locating request from the terminal satisfies the locating condition, step 305 may be directly performed to locate the terminal by using the grid-based feature parameter matching algorithm according to the locating feature parameter.

If the method according to this embodiment further includes the preferred step 303 in addition to step 301 and step 305, after step 301 is performed and it is verified in step 303 that the acquired locating feature parameter accommodates the locating requirement, step 305 may be directly performed to locate the terminal by using the grid-based feature parameter matching algorithm according to the locating feature parameter.

If the method according to this embodiment further includes the preferred step 304 in addition to step 301 and step 305, step 305 may be directly performed after step 301 is performed and a proper locating manner is selected in step 304 with reference to a service requirement and a geographic attribute of the terminal according to the locating feature parameter.

Nevertheless, the above preferred steps may also be performed as a combination with step 301 and step 305. This embodiment sets no limitation thereto, and gives no further description.

With the method according to this embodiment, pushing of such value-added services as location information and broadcast navigation assistance information, real-time traffic information may be achieved, locations of the to-be-rescued are accurately determined via the mobile communication network, thereby assisting rescue work of the rescuers. The method may also applied to transportation of goods in the logistics based on high-precision location-based mobile phones, and mobile phones may be located and monitored using the method according to the present invention, thereby acquiring real-time knowledge of the transportation routes and ensuring reliability in the logistics. In addition, the method according to the present invention may be further applied to monitoring and tracking on a special group by public security bureaus, facilitating working of the public security bureaus. Furthermore, the method according to the present invention may also be applied to other fields, and this embodiment sets no limitation to the specific application scenario.

With the method according to this embodiment, a locating feature parameter that is acquired after a terminal demodulates a received mobile broadcast signal is received from the terminal; and the terminal is located by using a grid-based feature parameter matching algorithm according to the locating feature parameter. This, on the premise of not affecting normal receiving and demodulation of mobile broadcast signals, not only achieves an effect of real-time and high-precision location and implements wide-area high-precision location and navigation of mass of terminals, but also implements integration of a broadcast system and a mobile communication system. In this way, the problem that the location technology of a wide-area mobile terminal mainly depends on a satellite navigation system is addressed from the location mechanism, and ground mobile broadcast network-based location effectively makes necessary and beneficial complementation for the satellite navigation system-based location.

### Embodiment 3

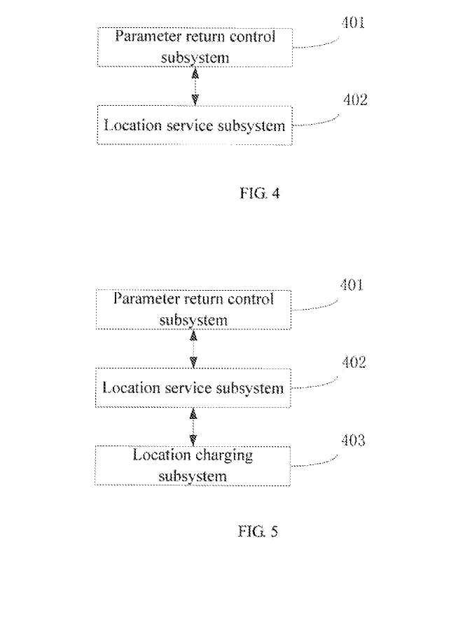

This embodiment provides a locating system. Referring to FIG. 4, the system includes: a parameter return control subsystem 401 and a location service subsystem 402.

The parameter return control subsystem 401 is configured to receive a locating request from a terminal and acquire a locating feature parameter from the terminal, and send the locating feature parameter to the location service subsystem, where the locating feature parameter is acquired by demodulating a locating spread spectrum signal inserted in a timeslot header or a transmission frame header of a mobile broadcast signal after the terminal receives the mobile broadcast signal.

The location service subsystem 402 is configured to locate the terminal by using a grid-based feature parameter matching algorithm according to the locating feature parameter sent by the parameter return control subsystem 401.

This embodiment sets no limitation to the specific locating feature parameter, the locating feature parameter may include but is not limited to one or more of a signal delay value, a signal delay difference, a signal strength, an angle of arrival, from each of mobile broadcast base stations to the terminal. The locating feature parameter is acquired by demodulating a locating spread spectrum signal inserted in a timeslot header or a transmission frame header of a mobile broadcast signal after the terminal receives the mobile broadcast signal. In practice, upon receiving a mobile broadcast signal, the terminal demodulates a locating spread spectrum signal inserted in a timeslot header or a transmission frame header of the mobile broadcast signal to acquire navigation message information, and measuring the navigation message information to acquire locating feather parameters. The navigation message information includes an identifier of the mobile base broadcast base stations, where the locating feature parameter corresponds to the identifier.

Preferably, the parameter return control subsystem 401 is further configured to determine whether the locating feature parameter accommodates a locating requirement.

Accordingly, the location service subsystem 402 is specifically configured to: locate the terminal by using the grid-based feature parameter matching algorithm according to the locating feature parameter, after the parameter return control subsystem 401 determines that the locating feature parameter accommodates the locating requirement.

Preferably, the parameter return control subsystem 401 is configured to select a proper locating manner with reference to a service requirement and a geographic attribute of the terminal according to the locating feature parameter.

Accordingly, the location service subsystem 402 is configured to locate the terminal by using a grid-based feature parameter matching algorithm according to the locating feature parameter and the locating manner selected by the parameter return control subsystem 401.

Preferably, the parameter return control subsystem 401 is further configured to verify whether the locating request from the terminal satisfies a locating condition.

Accordingly, the location service subsystem 402 is further configured to: after the parameter return control subsystem 401 verifies that the locating request satisfies the locating condition, locate the terminal by using the grid-based feature parameter matching algorithm.

The location service subsystem 402 is specifically configured to: perform an analysis of matching between the locating feature parameter and data in a locating feature parameter database by using the grid-based feature parameter matching algorithm, acquire a geographic location information parameter of the terminal, and process the geographic location information parameter online in a real-time manner to acquire a locating result.

Furthermore, referring to FIG. 5, the system further includes:

a location charging subsystem 403, configured to generate a charging record for each successful location.

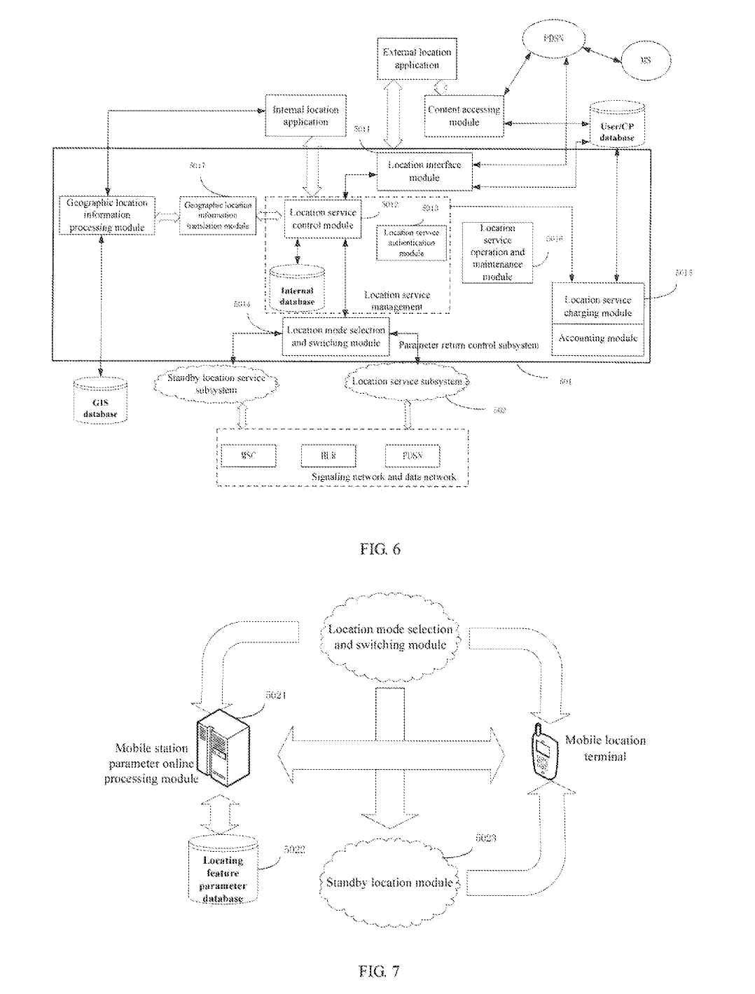

A parameter return control subsystem 501 and a location service subsystem 502 are described in detail in terms of specific structures with reference to the functions of the two subsystems. Firstly, the parameter return control subsystem 501 is based on an open service platform, and features openness and capability of modularized smooth capacity extension of the open service platform. The parameter return control subsystem 501 integrates with a geographic information system (GIS) interface, and supports complete personal privacy protection, and control and authentication of an accessed CP, and provides location information protection and personnel number protection for terminal users. Referring to the schematic structural diagram of the parameter return control subsystem 501 as illustrated in FIG. 6, function of each of these modules in the subsystem is described sequentially as follows:

The location interface module 5011: The parameter return control subsystem 501 provides a plurality of different access modes with respect to location applications, and employs an open platform environment. An operator may directly develop location applications on the platform, instead of cooperating with a CP. The location interface module 5011 is configured to: provide an interface for communication with an external location application (CP) and a packet data serving node (PDSN), receive a locating request from the external location application and a mobile terminal, translate the received locating request into an internal locating request format, assign a call identifier (ID), and send the call ID to the location service control module 5012 for processing of locating request.

The service location control module 5012 is mainly constituted by three parts, and is configured to: process and logically control a locating request, with respect to a locating request from a CP and a locating request from a mobile station (MS), use different location processes to request user's location from a location service subsystem according to the different locating request, perform authentication, provide a geographic location translation with the geographic location information translation module 5017, and temporarily store a final locating result into an internal database.

The location service authentication module 5013 is configured to: interface with a user/CP database, request user/CP authentication and authorization information from the user/CP database, and complete authentication and authorization check. The internal database temporarily stores user's location information, and data that needs to be temporarily stored in locating request processing.

The location mode selection and switching module 5014 is configured to receive the locating feature parameter from the mobile terminal and select a proper locating manner with reference to a service requirement and a geographic attribute of the terminal according to the locating feature parameter. During location of the terminal by using the grid-based location parameter matching algorithm according to the locating feature parameter, if few locating feature parameters are acquired or the precision of the received locating feature parameter is too low to accommodate the locating requirement, the location may fail. In this case, a standby location subsystem may be selected to relocate the terminal.

The location service charging module 5015 is configured to: with respect to a service initiated by a third party, generate a charging record for each successful location, provide a charging interface, and send the charging record to an accounting module (not illustrated in the drawings).

The location service operation and maintenance module 5016 is configured to provide operation and maintenance functions, i.e., platform management, application's statistical alarm management and configuration management.

The geographic location information translation module 5017 is configured to convert a location calculation result into local geographic coordinates, and provide the converted coordinates to an external GIS interface.

Referring to FIG. 6, the location service subsystem 502 may be connected to a mobile switching center (MSC), a home location register (HLR), and a PDSN in a signaling network and a data network. Referring to the schematic structural diagram of the location service subsystem as illustrated in FIG. 7, the location service subsystem 502 includes: a mobile station parameter online processing module 5021, a locating feature parameter database 5022, and a standby location module 5023. Functions of these modules in the subsystem are described sequentially as follows:

The mobile station parameter online processing module 5021 is configured to: perform an analysis of matching between the locating feature parameter and data in the locating feature parameter database 5022 by using a grid-based feature parameter matching algorithm, acquire a geographic location information parameter of the terminal, process the geographic location information parameter online in a real-time manner, calculate a reliability of locating result to send it to the parameter return control subsystem 501 and send the final location information parameter to the client.

The locating feature parameter database 5022 is configured to: perform an analysis and reasonably establish a model according to the collected locating feature parameter, research an intelligent planning model of the feature grid, through the intelligent planning model, acquire basic feature unit grids of adaptive size intelligently divided by feature database generation software according to the collected locating feature parameter values, to fuzzy matching of the locating feature parameter received in the location process. The content of the locating feature parameter database 5022 is as listed in Table 1 of Embodiment 2.

Further, data in the locating feature parameter database 5022 may be updated in real time according to construction of base stations, city infrastructures (for example, roads and houses), indoor location demands of the buildings, and electromagnetic environment changes. The locating feature parameter database 5022 is configured with a front-end server (which may be referred to as the data center of a grid feature parameter database) serving as an intermediate node for uploading locating feature parameter data. In cases where data is changed, the locating feature parameter data is uploaded to the front-end server, then calculated, analyzed, and verified, and finally updated to the locating feature parameter database 5022, thereby completing database update.

With the system according to the present embodiment, a locating feature parameter that is acquired after a terminal demodulates a received mobile broadcast signal is received from the terminal; and the terminal is located by using a grid-based feature parameter matching algorithm according to the locating feature parameter. This, on the premise of not affecting normal receiving and demodulation of mobile broadcast signals, not only achieves an effect of high-precision location and implements wide-area high-precision location and navigation of mass of terminals, but also implements integration of a broadcast system and a mobile communication system. In this way, the problem that the location technology of a wide-area mobile terminal mainly depends on a satellite navigation system is addressed from the location mechanism, and ground mobile broadcast network-based location effectively makes necessary and beneficial complementation for the satellite navigation system-based location.

It should be noted that, during provision of a location service by the locating system according to the above embodiments, the system is described by only using division of the above apparatuses as an example. In practice, the functions may be assigned to different apparatuses for implementation as required. To be specific, the internal structure of the system is divided into different apparatuses to implement all or part of the above-described functions. In addition, the locating system and the locating method according to the embodiments are based on the same inventive concept. Therefore, the detailed implementation can refer to the description of the method embodiments of the present invention, which is not described herein any further.

The sequence numbers of the preceding embodiments of the present invention are only for ease of description, but do not denote the preference of the embodiments.

All or part of the steps according to the embodiments of the present invention may be implemented by using hardware, or by issuing instructions to the hardware via a software program, and the software program may be stored in a readable storage medium, such as a compact disk or a hard disk.

Described above are merely preferred embodiments of the present invention, but are not intended to limit the present invention. Any modification, equivalent replacement, or improvement made without departing from the spirit and principle of the present invention should fall within the protection scope of the present invention.

1. A locating method, comprising:
receiving a locating request and a locating feature parameter from a terminal, wherein the locating feature parameter is acquired by demodulating a locating spread spectrum signal inserted in a timeslot header or a transmission frame header of a mobile broadcast signal after the terminal receives the mobile broadcast signal; and
locating the terminal by using a grid-based feature parameter matching algorithm according to the locating feature parameter.

2. The method according to claim 1, wherein prior to the locating the terminal by using a grid-based feature parameter matching algorithm according to the locating feature parameter, the method further comprises:
determining whether the locating feature parameter accommodates a locating requirement; and
accordingly, the locating the terminal by using a grid-based feature parameter matching algorithm according to the locating feature parameter comprises:
upon determining that the locating feature parameter accommodates the locating requirement, locating the terminal by using the grid-based feature parameter matching algorithm according to the locating feature parameter.

3. The method according to claim 1, wherein prior to the locating the terminal by using a grid-based feature parameter matching algorithm according to the locating feature parameter, the method further comprises:
selecting a proper locating manner with reference to a service requirement and a geographic attribute of the terminal according to the locating feature parameter; and
accordingly, the locating the terminal by using a grid-based feature parameter matching algorithm according to the locating feature parameter comprises:
locating the terminal by using a grid-based feature parameter matching algorithm according to the locating feature parameter and the selected locating manner.

4. The method according to claim 1, wherein prior to the locating the terminal by using a grid-based feature parameter matching algorithm according to the locating feature parameter, the method further comprises:
verifying whether the locating request from the terminal satisfies a locating condition; and
accordingly, the locating the terminal by using a grid-based feature parameter matching algorithm according to the locating feature parameter comprises:
upon verifying that the locating request satisfies the locating condition, locating the terminal by using the grid-based feature parameter matching algorithm.

5. The method according claim 1, wherein the locating the terminal by using a grid-based feature parameter matching algorithm comprises:
performing an analysis of matching between the locating feature parameter and data in a locating feature parameter database by using the grid-based feature parameter matching algorithm, acquiring a geographic location information parameter of the terminal, and processing the geographic location information parameter online in a real-time manner to acquire a locating result.

6. The method according to claim 1, wherein after the locating the terminal by using a grid-based feature parameter matching algorithm, the method further comprises:
generating a charging record for each successful location.

7. A locating system, comprising: a parameter return control subsystem and a location service subsystem; wherein:
the parameter return control subsystem is configured to receive a locating request and a locating feature parameter from a terminal, and send the locating feature parameter to the location service subsystem, wherein the locating feature parameter is acquired by demodulating a locating spread spectrum signal inserted in a timeslot header or a transmission frame header of a mobile broadcast signal after the terminal receives the mobile broadcast signal; and
the location service subsystem is configured to locate the terminal by using a grid-based feature parameter matching algorithm according to the locating feature parameter sent by the parameter return control subsystem.

8. The system according to claim 7, wherein the parameter return control subsystem is further configured to determine whether the locating feature parameter accommodates a locating requirement; and
accordingly, the location service subsystem is specifically configured to: after the parameter return control subsystem determines that the locating feature parameter accommodates the locating requirement, locate the terminal by using the grid-based feature parameter matching algorithm according to the locating feature parameter.

9. The system according to claim 7, wherein the parameter return control subsystem is further configured to select a proper locating manner with reference to a service requirement and a geographic attribute of the terminal according to the locating feature parameter; and
accordingly, the location service subsystem is specifically configured to locate the terminal by using a grid-based feature parameter matching algorithm according to the locating feature parameter and the locating manner selected by the parameter return control subsystem.

10. The system according to claim 7, wherein the parameter return control subsystem is further configured to verify whether the locating request from the terminal satisfies a locating condition; and
accordingly, the location service subsystem is further configured to: after the parameter return control subsystem verifies that the locating request from the terminal satisfies the locating condition, locate the terminal by using the grid-based feature parameter matching algorithm.

11. The system according to claim 7, wherein the location service subsystem is specifically configured to: perform an analysis of matching between the locating feature parameter and data in a locating feature parameter database by using the grid-based feature parameter matching algorithm, acquire a geographic location information parameter of the terminal, and process the geographic location information parameter online in a real-time manner to acquire a locating result.

12. The system according to claim 7, further comprising:
a location charging subsystem, configured to generate a charging record for each successful location.

13. The method according claim 2, wherein the locating the terminal by using a grid-based feature parameter matching algorithm comprises:
performing an analysis of matching between the locating feature parameter and data in a locating feature parameter database by using the grid-based feature parameter matching algorithm, acquiring a geographic location information parameter of the terminal, and processing the geographic location information parameter online in a real-time manner to acquire a locating result.

14. The method according claim 3, wherein the locating the terminal by using a grid-based feature parameter matching algorithm comprises:
performing an analysis of matching between the locating feature parameter and data in a locating feature parameter database by using the grid-based feature parameter matching algorithm, acquiring a geographic location information parameter of the terminal, and processing the geographic location information parameter online in a real-time manner to acquire a locating result.

15. The method according claim 4, wherein the locating the terminal by using a grid-based feature parameter matching algorithm comprises:
performing an analysis of matching between the locating feature parameter and data in a locating feature parameter database by using the grid-based feature parameter matching algorithm, acquiring a geographic location information parameter of the terminal, and processing the geographic location information parameter online in a real-time manner to acquire a locating result.

16. The system according to claim 8, wherein the location service subsystem is specifically configured to: perform an analysis of matching between the locating feature parameter and data in a locating feature parameter database by using the grid-based feature parameter matching algorithm, acquire a geographic location information parameter of the terminal, and process the geographic location information parameter online in a real-time manner to acquire a locating result.

17. The system according to claim 9, wherein the location service subsystem is specifically configured to: perform an analysis of matching between the locating feature parameter and data in a locating feature parameter database by using the grid-based feature parameter matching algorithm, acquire a geographic location information parameter of the terminal, and process the geographic location information parameter online in a real-time manner to acquire a locating result.

18. The system according to claim 10, wherein the location service subsystem is specifically configured to: perform an analysis of matching between the locating feature parameter and data in a locating feature parameter database by using the grid-based feature parameter matching algorithm, acquire a geographic location information parameter of the terminal, and process the geographic location information parameter online in a real-time manner to acquire a locating result.
